(19) United States
(12) Patent Application Publication
(10) Pub. No.: US 2009/0204527 A1
(43) Pub. Date: Aug. 13, 2009

(54) Currency Code for Soft Earning Unit

(76) Inventor: SAMIR SRIVASTAVA, Fremont, CA (US)

Correspondence Address: SAMIR SRIVASTAVA, 330 TUOLUMNE DRIVE, FREMONT, CA, 94539, US

(21) Appl. No.: 12/168,104

(22) Filed: Jul. 4, 2008

Related U.S. Application Data
(60) Provisional application No. 60/947,953, filed on Jul. 4, 2007.

(51) Int. Cl. G06Q 99/00

(52) U.S. Cl. 705/35; 705/1

(57) ABSTRACT

Hard Currency is used as common denominator to value product and services. In the complete digital world, this common denominator can be dealt only in computing devices and we don't need hard currencies. Henceforth it is further referred as Soft Earning Unit(s) (SEU). The invention is intended for extending Currency Code Table and multiplier for SEU's of different geographic region(s) used in various application(s) for SEU. The invention includes the changes for Credit and Debit Card for SEU environment. The invention also includes change in the computing infrastructure for SEU and mix of SEU and Hard Currency environment.

### CROSS-REFERENCE TO RELATED APPLICATIONS

This application claims the priority to U.S. Provisional Patent Application No. 60/947,953 filed Jul. 4, 2007, the content of which is herby incorporated herein by reference.

### FIELD

The present invention relates to database, application software, communication networks, computing devices and currency.

### BACKGROUND

Existing applications use database. Role of database is defined here for clarity purpose with respect to applications(s) in Appendix A.

Hard Currency is used as common denominator to value the product(s) and service(s). Different geographic region(s) have different currency code(s) and multiplier(s) for their conversion.

Current computing application(s) built with or without database, dealing in any way with value of products/services, or currencies use the Currency Code Table. Currency Code Table stores the Currency Codes for different geographic region(s). Based on the economic condition of different geographic region(s), these currencies have different multipliers for currency conversion. These multiplier(s) are stored in the currency code table or in different table. Currency Codes are three alphanumeric letters long. For example, for US Dollar we have USD as currency code and for Indian Rupees we have INR as currency code. For example 1 US Dollar is equivalent to 40 Indian Rupees at any point of time. This equivalence is depicted as 1 USD=40 INR for hard currency. Hard currency codes are available at http://www.xe.com/iso4217.htm

Currency Code Table is referred at the various places during the business processes/transactions. For an example a cost of product depends on the different supplier supplying the parts/raw materials etc from different geographic regions which have different hard currencies i.e. different hard currency codes. The manual effort is done to accomplish a usable furnished product in another geographic region which has altogether different hard currency code. The product is sold in the altogether different geographic region with different hard currency code. In this kind of application currency code table is referred at multiple times with different multipliers for different currency code to calculate the profit/loss and to do financial/business process analysis.

There is another example for currency code. When Credit/Debit cards are used in the different geographic regions to do the transactions as compared to where they are billed to payer.

FIG. 1, shows the one sample existing embodiment of Currency Code Table. FIG. 2, shows the sample embodiment of table for multipliers for hard currencies of different geographic region(s). FIG. 3 shows the sample embodiment where hard currency code and multipliers for them are stored in a single table. These embodiment(s) exist(s) within different commercially available databases currently. It can be possible these embodiment(s) exist in the applications. There may be other ways also in different application(s) and database(s) for dealing the hard currency/currencies of different geographic region(s). Other ways are examined as applicable to invention in the Description section.

### SUMMARY

The invention assumes complete digital world. In complete digital world, the common denominator to value products and services is handled only in the computing devices, henceforth referred as Soft Earning Unit (SEU). The invention pertains to modification of existing hardware, software, database and application for SEU and mix of SEU and hard currency environment. The invention includes changes adoption of Credit and Debit Cards also for this.

### BRIEF DESCRIPTION OF DRAWINGS

FIG. 1) shows the existing Hard Currency Code Table with Sample Entries for Existing Application(s).

FIG. 2) shows Hard Currency Conversion Multipliers Table with Sample Entries for Existing Application(s).

FIG. 3) shows Hard Currency Code with Multipliers in a single table with Sample Entries.

FIG. 4) shows Single Table with Currency Codes and multipliers for hard currency and SEU with sample entries.

FIG. 5) shows Currency Code Table for SEU with sample entries.

FIG. 6) shows Sample C Programming Language Code for hardcoded Currency Codes for SEU.

FIG. 7) shows Sample Configuration File for Currency Code(s) for SEU

FIG. 8) shows Sample Storage of currency code(s) for SEU within memory using C Programming Language

FIG. 9) shows Multiplier table with Sample Entries for SEU

FIG. 10) shows Sample Code for Hardcoded multipliers for SEU in C Programming Language

FIG. 11) shows hardware and software overview for SEU and mix of SEU and/or hard currency environment.

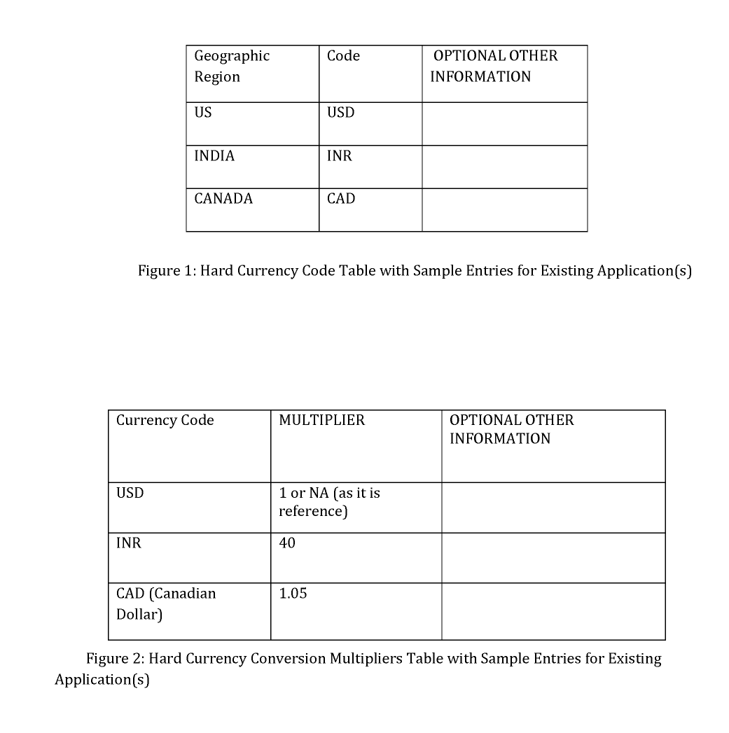

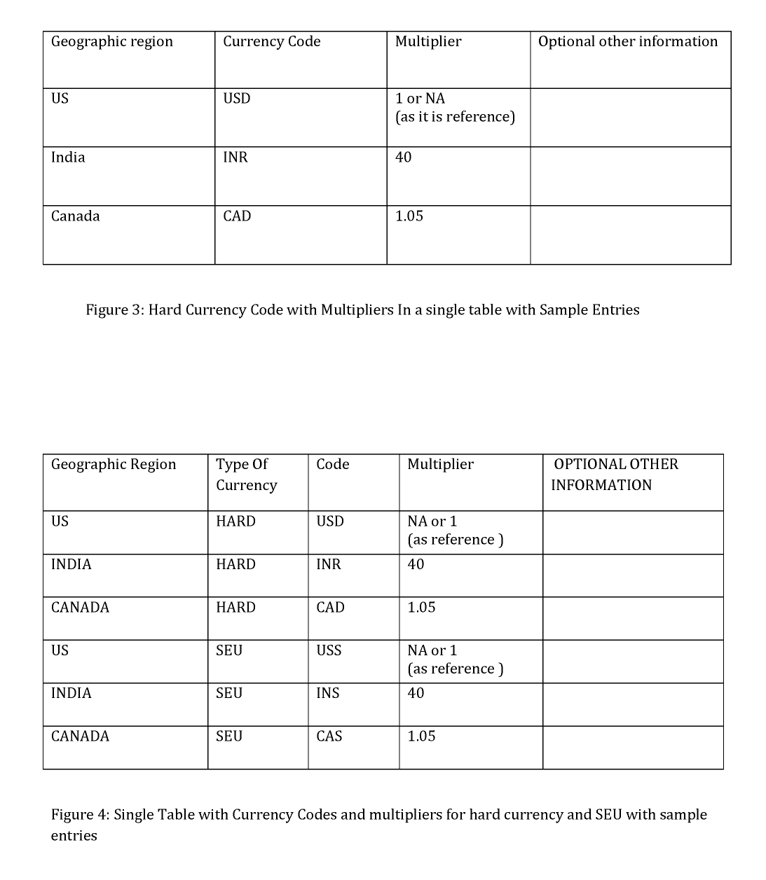

The sample values used in the figures are just for the purpose of example. Invention is not limited by the values used.

### DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In the complete digital world or (sub) geographic region connected with computing device(s) capable of doing business transaction, the common denominator to value the product(s) and/or service(s) is dealt in the computing device(s) only. Hard currency doesn't exist in complete digital world or (sub) geographic region. The common denominator for valuing the product(s); service(s); living beings such as animals, trees etc; fixed assets such as real estate which is dealt only in the computing device(s) is referred as Soft Earning Unit(s) (SEU) further. Here service(s) term is used very generically, it means to include services such as but not limited to gardening, cleaning, network services, consulting services. Geographic region can be viewed as country, group of countries, states, cities etc.

The values used in the figures and below description for SEU such as INS (Indian SEU), geographic regions (such as India) etc are just for exemplary purpose. Invention is not limited by the values used.

The migration plan of SEU can be decomposed into operational model, when transaction above/below some limiting value will be in SEU and others are in hard currencies. When system is verified for SEU, then all transactions without any limiting value will be in SEU within that geographic area. There will be time intervals when some geographic have adopted SEU and others have not adopted it. During this time interval similar to existing currency conversion will apply which will convert the SEU of one geographic region to hard currency of other geographic region and vice versa. When two geographic region(s) in question, where payer and payee entities/persons are situated have adopted SEU, then SEU conversion will be done as of two hard currencies are converted now.

FIG. 4 shows one embodiment of currency code table with conversion multipliers. In this embodiment currency code(s) for SEU and hard currency/currencies for a geographic region both exist with multipliers. In this embodiment, there is extra column added for the type of currency i.e. hard currency or SEU. According to another possible embodiment, geographic region(s) can be changed as US (for US Hard Currency) and US-SEU (for US-SEU). Both US and US-SEU exist in the table. Application(s) and/or database engines have the intelligence when to refer the hard currency and when to refer SEU within the same geographic region. Both types of currencies (hard currency and SEU) will be referred only during the transition time interval based on different criterion (such as size of transaction is above/below some limit). When geographic region(s) adopt(s) the SEU completely, then hard currency code(s) with its multiplier and (optionally with type of currency information) may be deleted from the table. In another embodiment, the entry for unused hard currency for adopted region exists in the table but it is not referred by the application(s) and/or database engines. For example INR stands for Indian Rupees in hard currency and INS Indian SEU. INS is just an example. During the transition interval INR and INS both are referred but after the transition only INS is referred. Values given are just for exemplary purpose. Code for SEU can be any alphanumeric, special characters, symbols etc. Invention is not constrained by the particular value used in the example.

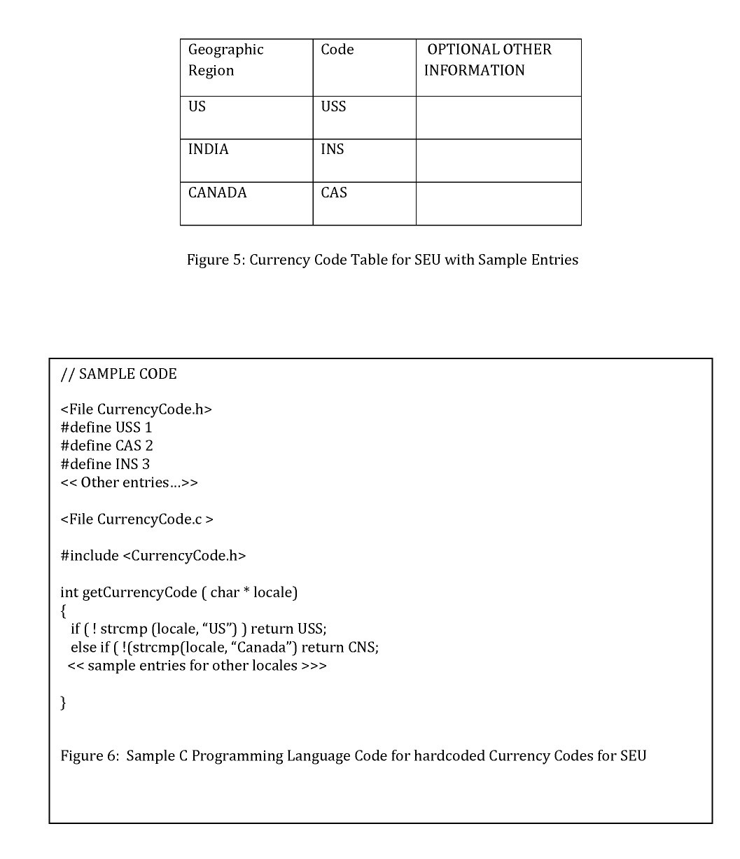

According to yet another embodiment as shown in FIG. 5, there will be new table created for SEU codes. In this case, hard currency code table is not changed. Application(s) will be ported/changed and developed for incorporating this new table. Existing application(s) will use the same existing table for the duration when hard currency is acceptable. For transaction(s) within the geographic region(s) which have adopted the SEU, the existing hard currency code table will not be used. When world moves completely to the SEU environment, then existing hard currency code table will not be used. There will be linkage between the hard currency code table and new currency code table of SEU. This linkage can be by any means (such as by value, by reference etc) or application(s) or database engine(s) have the intelligence of their relationship. There will be separate multiplier table for SEU conversions of different geographic regions. In a different embodiment, the existing multiplier of hard currency is enhanced to store the multipliers for SEU also similar to FIG. 2.

According to yet another embodiment, currency codes are not collected at one place in a table but they are hardcoded in the code. FIG. 6, shows the sample C language code for hardcoded SEU currency code for one of the embodiment. Here SEU currency codes are used directly. There can be other alternative ways to hardcode the currency code(s) for SEU in various computing language(s). Invention is not limited by the computing language(s) used and the way to hardcode the currency code(s) for SEU provided by that computing language.

According to yet another embodiment, currency codes are taken from the user configuration. User configuration input can be taken by any means such as user enters the complete code, or user is prompted to select from the pull down menu. Optionally, after user's selection, the currency code is passed to the application(s).

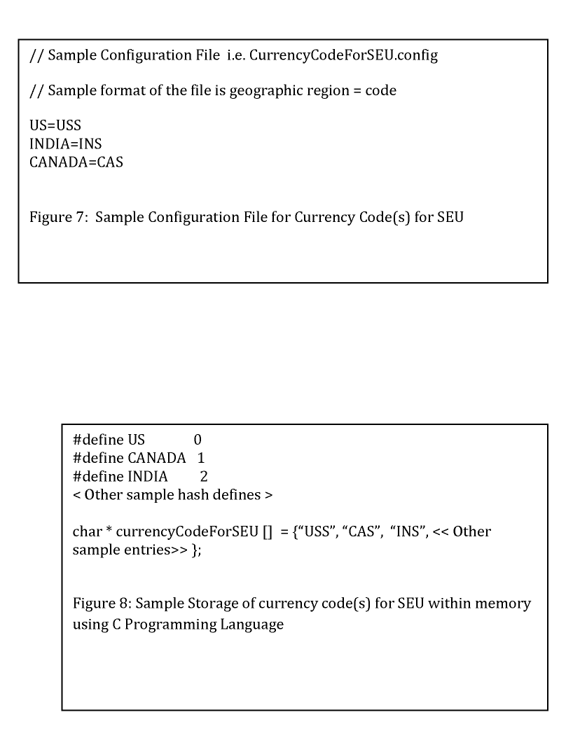

According to yet another embodiment, currency codes are stored/referred from the configuration file. FIG. 7, shows the sample configuration file containing the currency codes for SEU. It shows the sample format of the file. Invention is not limited by the format used and type of the file and presence of file and other variables. It is just an example to depict the concept.

According to yet another embodiment, currency codes for SEU are stored/referred from the memory. In the memory currency codes are stored in any kind of data structures such as array(s), linked list(s), tree(s) and hash table(s). FIG. 8 shows the sample code for one embodiment of array data structures using C language. Invention is not limited by the computing language(s) used and methods and/or mechanisms of language(s) used for storing it.

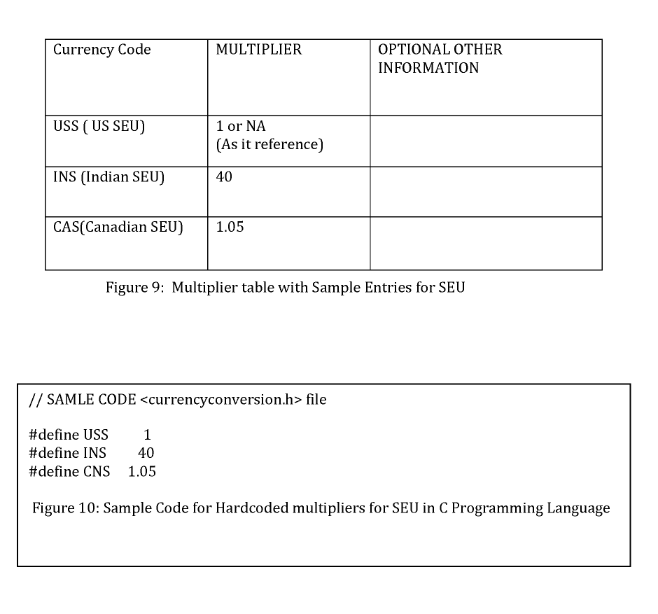

According to yet another embodiment, the multiplier(s) for SEU conversion for different geographic region(s) are stored in different table. Currency Code table and multiplier table are two different tables for SEU. FIG. 9 shows the sample entries for SEU conversion table. Application(s) and/or database(s) have the intelligence to relate/link currency code(s) with their multiplier(s) for SEU and/or hard currency.

According to yet different embodiment, multiplier(s) can be used directly or hardcoded within database engine(s) and/or application(s). FIG. 10 shows the sample C code for hardcoded multiplier value(s). These values can be read the configuration file or memory. These values can be stored in the configuration file or memory using any mechanism.

According to yet different embodiment, multiplier(s) for SEU with or without currency codes can be operated (such as stored, updated, referred and deleted) in any combination of hardware and software.

According to yet another embodiment, multiplier(s) for SEU are exchanged, referred, passed in plurality of signal(s) between/among different computing entities/entity. These computing entities/entity can be on the same physical machine or on different physical machines. For example these computing entities can be a process, thread or modeled as a service. Invention is not limited by the type of computing entity. It can be any executable code which is running in any context using a processor with/without memory and/or input/output device(s) and/or any networking or communication capability.

According to yet another embodiment, different computing languages provide utilities to access currency codes. For example Java provides classes for handling currency codes within the language itself. These classes or new classes can be changed/developed in many ways for SEU and mix of SEU and hard currency environment. Invention is not limited by the computing language and its mechanisms used.

In the above specifications of different embodiments, the modified currency code in any form such as table (partial/complete) may be stored in any format (such as encrypted/unencrypted and/or password protected/unprotected) in any combination of hardware or software. Security related procedures such as authentication, authorization etc are applicable to various embodiments described above.

In the above specifications of the different embodiments are applicable to any database such as ORACLE, PEOPLESOFT, INFORMIX, SAP etc. They are applicable to in memory databases such as TimesTen also. These names given are just an example. There can be all together new database and/or application developed for SEU. Above specification are applicable to that also. Specifications are applicable to access of database(s) using different abstraction layers also. They are not constrained by database and/or application used. Invention pertains to extending the currency codes and multipliers for SEU of different geographic region(s) for database(s) and application(s).

According to yet another embodiment, different computing languages provide utilities to access currency codes. For example Java provides classes for currency code(s) e.g. java.util.currency (Version 1.4). Refer latest details from http://java.sun.com. Invention is not limited by the computing language and its mechanisms used.

Invention also includes credit card and debit card for SEU with or without currency codes/multipliers for SEU. Credit Card is mode of payment where payer pays using it to payee. Payee collects the funds from the credit card issuing entity and credit card issuing entity settles the funds from the payer based on the billing cycle. In case of debit card, funds are transferred by the debit card issuing entity to the payee from the payer's account when transaction is done. There is no concept of billing cycle in this case. When payee and payer are in different geographic regions, then the currency codes and multiplier values are used. Application(s) and/or database engine(s) at the backend take care of this conversion. In both (credit and debit cards) cases, there is somewhere fund settlement is done in hard currency. Invention pertains to removal of hard currency in the fund settlement cycle for SEU environment and/or usage of currency codes with or without multipliers for SEU. Credit Cards for hard currency provides the hard currency as cash advance, But Credit Cards for SEU will provide only the SEU to user's portable/unportable computing device. Debit cards also provide cash from the user's financial accounts, if cash is available. Debit card for SEU will also provide the SEU to user's portable/unportable computing device based on the availability of the funds in SEU for user. Here computing device means to include any device capable of performing transaction(s) in SEU. It means to include but not limited to cell phone, pager, PDA, IP (Internet Protocol) phone, PSTN Phone, PC (Personal Computer), Servers, Clients, Diskless Servers, Laptop, e-machines, smart appliances such as smart meters.

Invention includes any changes in hardware, software and applications with or without database for SEU and mix of hard currency and SEU environment. Here applications means to include computing as well as non-computing such as check mode of payment, money orders. For non-computing application such as check mode of payment, there will be no hard currency equivalent for it. These checks dealing in SEU cannot be cashed. The funds in SEU format will be transferred from the payer account to payee account.

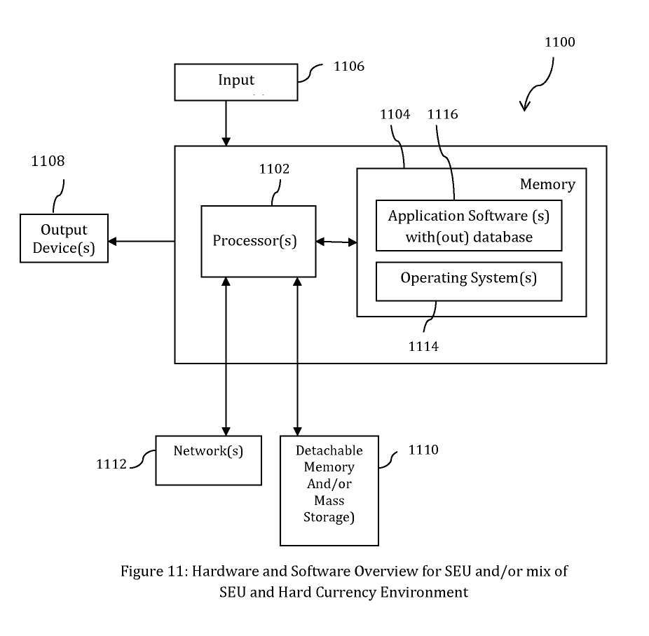

In the following description of FIG. 11 computing applications are described. FIG. 11 can be viewed as for changing the existing infrastructure or development of brand new infrastructure for SEU. FIG. 11 of the drawings shows a system 1100 for correcting a distorted image using the techniques described above, in accordance with one embodiment of the invention. The system 1100 typically includes at least one processor 1102 coupled to a memory 1104. The processor 1102 may represent one or more processors (e.g., microprocessors), and the memory 1104 may represent random access memory (RAM) devices comprising a main storage of the system 1100, as well as any supplemental levels of memory e.g., cache memories, non-volatile or back-up memories (e.g. programmable or flash memories), read-only memories, etc. In addition, the memory 1104 may be considered to include memory storage physically located elsewhere in the system 1100, e.g. any cache memory in the processor 1102.

The system 1100 also typically receives a number of inputs and outputs for communicating information externally. For interface with a user or operator, the system 1100 may include one or more user input devices 1106 (e.g., a keyboard, a mouse, a scanner etc.) and a display 1108 (e.g., a Liquid Crystal Display (LCD) panel). For additional storage, the hardware 1100 may also include one or more mass storage devices 1110, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 1100 may include an interface with one or more networks 1112 (e.g., a local area network (LAN), a wide area network (WAN), a wireless network, and/or the Internet among others) to permit the communication of information with other computers coupled to the networks. It should be appreciated that the system 1100 typically includes suitable analog and/or digital interfaces between the processor 1102 and each of the components 1104, 1106, 1108 and 1112 as is well known in the art.

The system 1100 operates under the control of an operating system 1114, and executes various computer software applications, components, programs, objects, modules, etc. indicated collectively by reference numeral 1116 to perform the correction techniques described above.

The system 1100 when modeled for the existing applications is changed for adopting the SEU and mix of hard currency and SEU environments in many ways. According to one embodiment of this system, currency codes and multipliers are modified within the Database. Invention includes adoption of the system in 1100 to SEU and mix of hard currency and SEU environment by any mechanisms and/or methods.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

### Appendix A

Databases are commonly used for storing large quantities of similar or dissimilar data on digital systems. These databases typically follow a particular data model defined by database-specific features such as the selection of tables and table fields containing fields of the database, the data types of the various database fields, and so forth. In a key-based database system, one or more key columns are included in each table to associate the fields of a given database record across tables and table columns.

In addition to the data model, the database system architecture defines other operational characteristics of the database. For example, the database system typically will incorporate or be compatible with certain data operators that are available for combining, comparing, sorting, retrieving, or otherwise manipulating the various columns of data. Relational databases and some other databases are commonly configured to be manipulated using structured query language (SQL) queries.

Still further, the stored data itself further defines operational characteristics of the database. For example, text-based data is stored in a selected language, such as English, French, or so forth. Numeric quantities may be stored in particular units, such as monetary U.S. dollars or European euros. Time values may be specific to a particular time zone.

The effect of these various factors is to constrain a user or database application programmer to interact with the database using a rigid and inflexible format. Input data or queries are configured or structured in the language used for the textual data of the database, and receive search results or other database output in that language. If the database is in French, for example, then a user who inputs data in English or constructs queries in English will generally cause or receive adverse results. Similarly, database searching is limited to the available data operators, SQL commands, or other available search tools, and search parameters must be inputted in the language used for text entries of the database. Still further, the user dialog box displays field names and other descriptive text in the database language, making it difficult or impossible for a user unfamiliar with that language to successfully interact with the database.

An application programmer who wants to add additional functionality to the database has to write extensive code to implement the additional functionality. Moreover, this extensive code must be incorporated into each database application that accesses the additional functionality. In a typical commercial setting, the database system is provided by a first software vendor, the database is constructed in-house, and various database application programs are optionally provided by third party vendors. Each vendor develops separate and distinct programming code for extending functionality of the database in different ways, which introduces difficulties in cross-vendor software compatibility and forces the database user to deal with various different user interfaces. Moreover, there may be substantial difficulty in adapting a given commercial application program to the existing data model defined by the tables and their structure.

There are application(s) with above issues are deployed and we have other application(s) which fixes the above issues with an abstraction layer. For clarification, the abstraction layer functionality is described below.

An abstraction layer for a database contains database records each including a plurality of fields stored in one or more tables, the fields being associated with the record by a key disposed in at least one key column of each of the one or more tables. The abstraction layer includes a key column identifier that identifies the at least one key column, and one or more metadata tables containing metadata relating to the database. The one or more metadata tables include at least a controls table containing control records corresponding to fields of the database. The control record for each field includes at least a control key associating the control record with the field and at least one metadatum corresponding to the field.

The invention is applicable to underlying different databases which are accessed through different metadata and/or abstraction layer

1) The common denominator for valuing of different product(s), service(s), fixed asset(s), living being(s) etc, which is dealt only in computing device(s), is referred as Soft Earning Unit(s) (in further claims referred as SEU). Invention is not limited by acronym or name used for it.

2) Currency Codes for SEU for different geographic region.

3) Adopting Credit and Debit Cards for SEU with or without Currency Code for SEU.

4) Currency Codes for SEU are added to the same currency code table that is used for hard currency codes.

5) Hard Currency Codes and SEU codes both are referred during transition time intervals.

6) Hard Currency Codes from the Currency Code Table are deleted from the Currency Code table, after SEU adoption.

7) Hard Currency Codes from the Currency Code Table are not deleted, after SEU adoption.

8) If as per claim 7, hard currency codes are not deleted from the Currency Code Table, but they are not referred when SEU is adopted.

9) Partial or Complete Currency Code Table is stored in any format in any combination of hardware and/or software.

10) Plurality of signal(s) is used by different entities for exchanging partial or complete currency code table entries.

11) New Table for Currency Codes for SEU is created.

12) New Table in claim 11 is linked to Hard Currency Code table.

13) Linkage in claim 12 is not used, after the transition from hard currency to SEU.

14) Currency Codes for SEU are hard coded in the applications, instead referring from the table.

15) Currency Codes for SEU is stored/referred in/from Configuration file.

16) Currency Codes for SEU are referred from user configuration.

17) Currency Code table for SEU is stored/referred in/from memory.

18) Multipliers for Currency Codes for SEU of different geographic region(s) are stored/referred in/from a separate table.

19) Multipliers for SEU and currency code for SEU are placed/referred in/from single table.

20) Multipliers and currency codes for SEU and/or hard currency are placed/referred in/from a single table.

21) Currency Code table for SEU and/or multiplier(s) for SEU are stored and/or referred using any type of data structure or in any form in memory.

22) Multiplier(s) for SEU of different geographic region are hardcoded or directly used within database and/or application.

23) Multipliers for SEU are operated (i.e. stored/updated/referred/deleted) in any combination of hardware and software.

24) Multipliers for SEU and/or currency codes for SEU are used in plurality of signal(s).

25) Security related procedures are applicable to above claims 1 to 24 for dealing SEU directly or with their codes.

26) Above claims 1 to 25 are applicable to any application which deals in SEU.

27) Above claims 1 to 25 are applicable to any database.

28) Any change in database and/or software and/or hardware and/or application for SEU environment.

29) Any change in database and/or software and/or hardware and/or application for mix of hard currency and SEU environment.

30) New database and/or software and/or hardware and/or application developed for SEU and mix of hard currency and SEU environment.

31) Any change in non-computing application for SEU and mix of hard currency and SEU environment.

32) Elimination of hard currency by SEU within the completely digitally connected (sub) geographic region.
